(19) United States
(12) Patent Application Publication
(10) Pub. No.: US 2014/0009246 A1
(43) Pub. Date: Jan. 9, 2014

(54) NETWORK SIGNAL ENHANCEMENT CIRCUIT ASSEMBLY

(71) Applicant: AJOHO ENTERPRISE CO., LTD., Taipei City (TW)

(72) Inventors: Chia-Ping MO, Taipei City (TW); You-Chi LIU, Taipei City (TW)

(73) Assignee: AJOHO ENTERPRISE CO., LTD., Taipei City (TW)

(21) Appl. No.: 14/021,276

(22) Filed: Sep. 9, 2013

Related U.S. Application Data
(63) Continuation-in-part of application No. 13/544,538, filed on Jul. 9, 2012.

(30) Foreign Application Priority Data
Apr. 6, 2012 (TW) 101112238

(51) Int. Cl. H03H 7/38; H04B 3/28

(52) U.S. Cl. CPC H04L 25/03878
USPC 333/131; 333/12

(57) ABSTRACT

A network signal enhancement circuit assembly includes a processing circuit installed in a circuit board and having opposing first and second connection ends thereof respectively coupled to a network connector and a voltage-mode network-on-chip. The processing circuit includes coupling modules for coupling network signals, EMI protection modules for removing noises from coupled network signals, and a signal enhancement module including a voltage source and a plurality of pull-up resistors and adapted to compensate for an attenuation of the network signal due to long distance signal transmission, assuring a high level of signal transmission stability.

This application is a Continuation-In-Part of Application Ser. No. 13/544,538, filed on Jul. 9, 2012, for which priority is claimed under 35 U.S.C. §120, the entire contents of which are hereby incorporated by reference.

### BACKGROUND OF THE INVENTION

1. Field of the Invention

The present invention relates to network technology and more particularly, to a network signal enhancement circuit assembly, which uses a signal enhancement module to compensate for an attenuation of the transmitting signal due to long distance signal transmission, thereby effectively solving signal attenuation and distortion problems assuring a high level of signal transmission stability.

2. Description of the Related Art

Following fast development of computer technology, desk computers and notebook computers are well developed and widely used in different fields for different applications, it is the market trend to provide computers having high operating speed and small size. Further, network communication technology brings people closer together, helping people to gather information about living, learning, working and recreational activities. By means of network communication, people can communicate with one another to send real time information, advertising propaganda or e-mail. Further, through the internet, people can search information, send instant messages, or play on-line video games. The development of computer technology makes the relationship between people and network unshakable and inseparable.

Further, a network signal processing circuit A for processing network signals is known comprising a first connection end B and a second connection end C respectively electrically connected to a network connector and a network-on-chip, a plurality of two-wire channels D connected in parallel between the first connection end B and the second connection end C for transmitting network signals from the network connector at the first connection end B to the network-on-chip at the second connection end C, a plurality of coupling modules E each having two coupling capacitors E1 respectively electrically connected in series to the two wires D1 of one respective two-wire channel D for coupling network signals, and a plurality of filter modules F each having two filter inductors F1 respectively electrically connected in series to the two wires D1 of one respective two-wire channel D for removing high-frequency noises. Further, the transmission of network signals can be done in a wired transmission manner or a wireless transmission manner. If the transmission distance is short, the signal transmission is stable. However, when transmitting a network signal through a long transmission distance, an attenuation of the network signal may occur, lowering the network signal transmission performance and leading to signal instability or signal distortion problems.

Thus, when a network processing circuit receives a network signal from a remote electronic apparatus through a long transmission distance and long transmission time, problems due to signal attenuation, distortion and instability may occur. The use of signal coupling means and signal filter means in a network processing circuit cannot compensate for an attenuation of the received network signal, resulting in data transmission instability or decreased transmission speed.

Therefore, it is desirable to provide a network processing circuit that eliminates the aforesaid problems.

### SUMMARY OF THE INVENTION

The present invention has been accomplished under the circumstances in view. It is therefore the main object of the present invention to provide a network signal enhancement circuit assembly, which uses a signal enhancement module to compensate for an attenuation of the transmitting signal due to long distance signal transmission, thereby effectively solving signal attenuation and distortion problems assuring a high level of signal transmission stability.

To achieve this and other objects of the present invention, a network signal enhancement circuit assembly in accordance with the present invention comprises a circuit board, and a processing circuit installed in the circuit board and having opposing first and second connection ends thereof respectively coupled to a network connector and a voltage-mode network-on-chip. The processing circuit comprises coupling modules electrically coupled to two-wire channels between the opposing first and second connection ends for coupling network signals, EMI protection modules electrically coupled to two-wire channels between the opposing first and second connection ends for removing noises from coupled network signals, and a signal enhancement module including a voltage source and a plurality of pull-up resistors electrically connected to the voltage source and respectively electrically connected in parallel to the wires of two-wire channels of the processing circuit between the opposing first and second connection ends and adapted to compensate for an attenuation of the coupled network signal due to long distance signal transmission, assuring a high level of signal transmission stability.

### BRIEF DESCRIPTION OF THE DRAWINGS

FIG. 1 is a block diagram of a network signal enhancement circuit assembly in accordance with the present invention.

FIG. 2 is a circuit diagram of the processing circuit of the network signal enhancement circuit assembly in accordance with the present invention.

FIG. 3 is an alternate form of the block diagram of the network signal enhancement circuit assembly in accordance with the present invention.

FIG. 4 is a circuit diagram of an alternate form of the processing circuit of the network signal enhancement circuit assembly in accordance with the present invention.

FIG. 5 is a signal waveform curved obtained according to the present invention.

FIG. 6 is circuit diagram of a network signal enhancement circuit assembly according to the prior art.

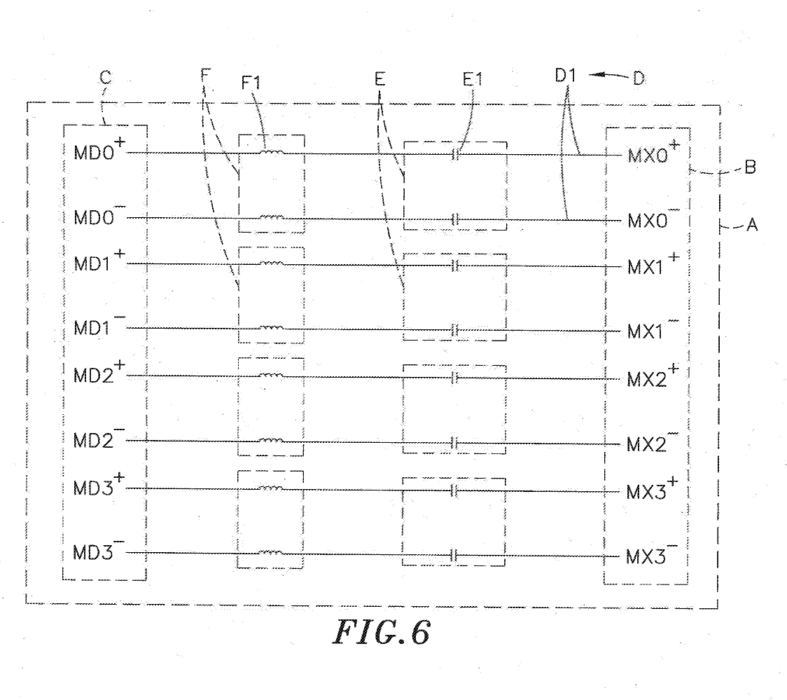

### DETAILED DESCRIPTION OF THE PREFERRED EMBODIMENT

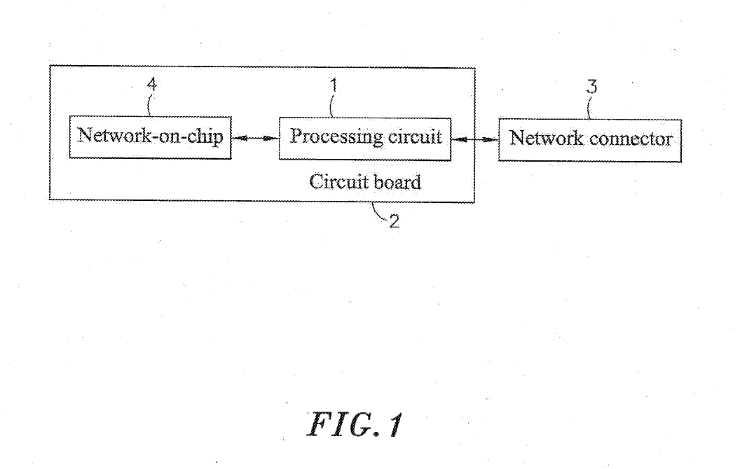

Referring to FIGS. 1-4, a network signal enhancement circuit assembly in accordance with the present invention is shown. As illustrated, the network signal enhancement circuit assembly comprises a circuit board 2 and a processing circuit 1.

The processing circuit 1 is installed in the circuit board 2, comprising a first connection end 10, a second connection end 11, a plurality of two-wire channels 12 electrically connected in parallel between the first connection end 10 and the second connection end 11, and a plurality of coupling modules 13 and EMI protection modules 14 and a signal enhancement module 15 respectively electrically coupled between the first connection end 10 and the second connection end 11 in a proper order where the coupling modules 13 are set between the first connection end 10 and the EMI protection modules 14; the EMI protection modules 14 are set between the coupling modules 13 and the signal enhancement module 15; the signal enhancement module 15 is set between the EMI protection modules 14 and the second connection end 11. Each two-wire channel 12 is formed of two wires 121. Each coupling module 13 comprises two first capacitors 131 respectively electrically connected in series to the two wires 121 of the respective two-wire channel 12. Each EMI protection module 14 comprises two second capacitors 141 that are electrically connected in series and then electrically connected in parallel to the two wires 121 of the respective two-wire channel 12 with the connecting point between the two second capacitors 141 electrically connected to a common grounding terminal 142, and two inductors 143 respectively electrically connected in series to the two second capacitors 141. The signal enhancement module 15 comprises a voltage source 151 that can be city power supply, power generator or storage battery, and a plurality of pull-up resistors 152 (of resistance value in the range of 100 Ohm˜100K Ohm, or preferably 10K ohm) electrically connected to the voltage source 151 and respectively electrically connected in parallel to the wires 121 of selected two-wire channels 12. Thus, a predetermined external bias voltage can be obtained through the voltage source 151, and then regulated by the pull-up resistors 152 and then respectively provided by the pull-up resistors 152 to the respective wires 121 of the two-wire channels 12 to enhance signal strength and signal transmission stability.

Further, the number of the two-wire channels 12 of the processing circuit 1 can be, for example, 4, wherein the wires 121 of the two-wire channels 12 of the processing circuit 1 are respectively electrically connected to pins MX0⁺, MX0⁻, MX1⁺, MX1⁻, MX2⁺, MX2⁻, MX3⁺ and MX3⁻ at the first connection end 10, and pins MD0⁺, MD0⁻, MD1⁺, MD1⁻, MD2⁺, MD2⁻, MD3⁺ and MD3⁻ at the second connection end 11. However, this configuration layout is changeable to fit different design requirements.

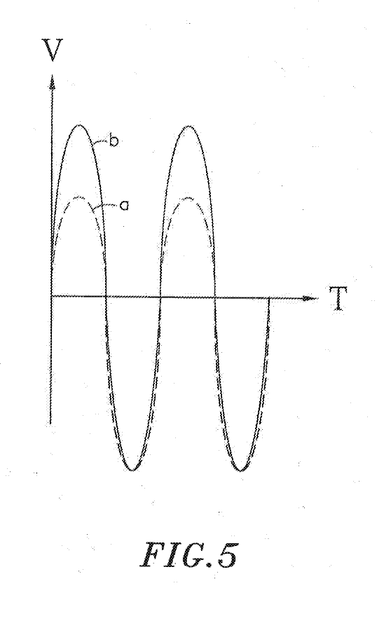

Referring to FIG. 5 and FIGS. 1 and 2 again, after installation of the processing circuit 1 in the circuit board 2, the first connection end 10 and second connection end 11 of the processing circuit 1 are respectively electrically coupled to a network connector 3 and a network-on-chip 4. Thus, the first connection end 10 can receive an inputted network signal from the network connector 3 and transmit the received network signal through the wires 121 of the two-wire channels 12 toward the second connection end 11 and the network-on-chip 4. At this time, the first capacitors 131 of the coupling modules 13 couple the inputted network signal, and then high frequency noises and low frequency noises are effectively removed from the network signal by the second capacitors 141 and inductors 143 of the EMI protection modules 14, and at the same time, the bias voltage provided by the voltage source 151 of the signal enhancement module 15 is regulated by the pull-up resistors 152 and then respectively provided by the pull-up resistors 152 to the respective wires 121 of the two-wire channels 12 to compensate an attenuation of the signal due to long distance signal transmission (see wave a in FIG. 5 where T: time; V: voltage level), enabling the network signal to be boosted to the voltage level of the original signal (see wave b in FIG. 5). Thus, the invention effectively solves signal attenuation and distortion problems due to long distance signal transmission, giving proper compensation and assuring a high level of signal transmission stability.

Further, the higher of rated resistance values of the pull-up resistors 152 of the signal enhancement module 15, the lower the bias voltage provided by the voltage source 151 to the inputted network signal will be; the lower of rated resistance values of the pull-up resistors 152 of the signal enhancement module 15, the higher the bias voltage provided by the voltage source 151 to the inputted network signal will be. Thus, pull-up resistors 152 of different resistance values can be selectively coupled to the wires 121 of the two-wire channels 12 subject to the transmission distance of the network signal received by the first connection end 10 from the network connector 3 and the working bias voltage of the network-on-chip 4 that is electrically connected to the second connection end 11, enabling the bias voltage provided by the voltage source 151 to be respectively and properly shunted and regulated by the pull-up resistors 152 and then provided by the respective pull-up resistors 152 to the network signal in every wire 121, and thus the voltage of the network signal can be raised to the voltage level of the original signal to match with the rated working bias voltage of the network-on-chip 4.

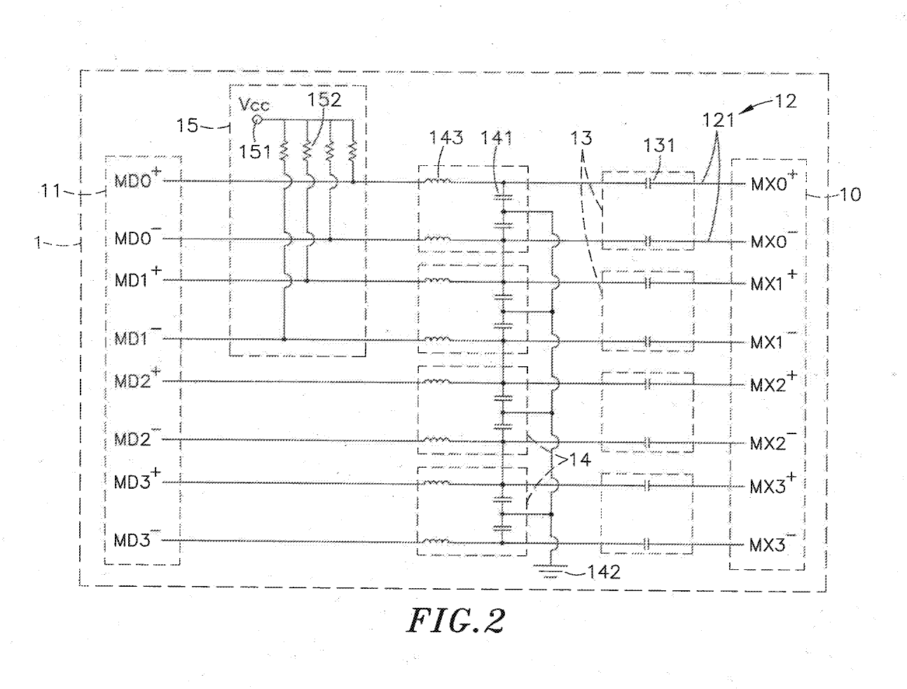

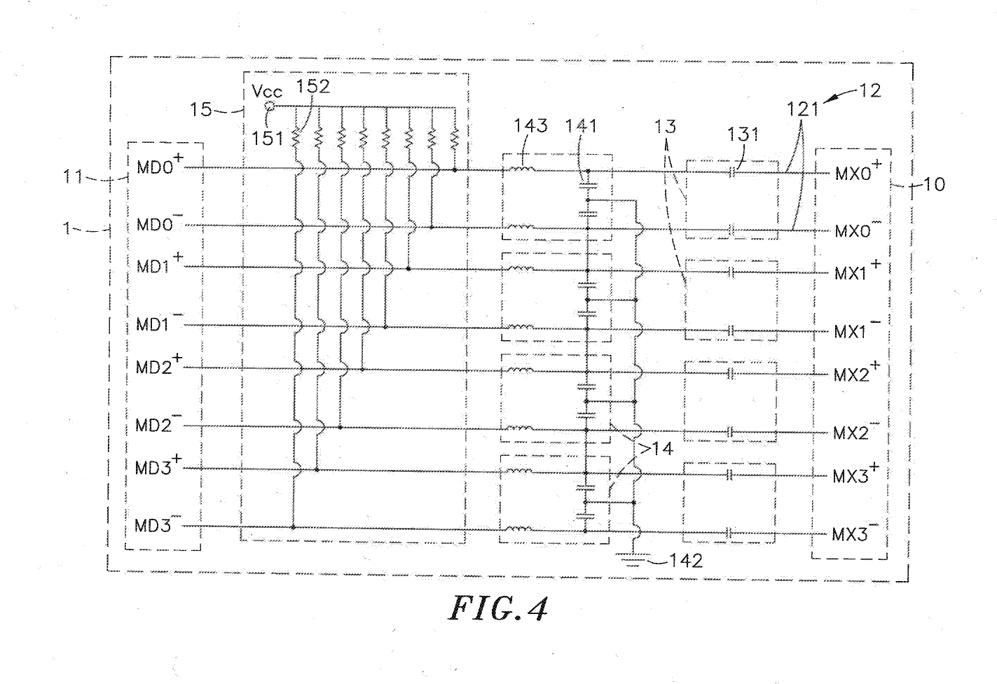

Referring to FIG. 4, a circuit diagram of an alternate form of the processing circuit 1 is shown. During operation of the is processing circuit 1 to transmit data, the number of the two-wire channels 12 to be used is determined subject to the network transmission speed. For example, if the network transmission speed is in the range of 10 Mbps˜100 Mbps (see FIG. 2), it requires only two two-wire channels 12, and the signal enhancement module 15 simply needs to use four pull-up resistors 152 to electrically connect the voltage source 151 in parallel to the four wires 121 of the two two-wire channels 12. If the network transmission speed is in the range of 10 Mbps˜1 Gbps or 10 Gbps or even over 10 Gbps (see FIG. 4), it requires four two-wire channels 12, and the signal enhancement module 15 needs to use eight pull-up resistors 152 to electrically connect the voltage source 151 in parallel to the eight wires 121 of the four two-wire channels 12.

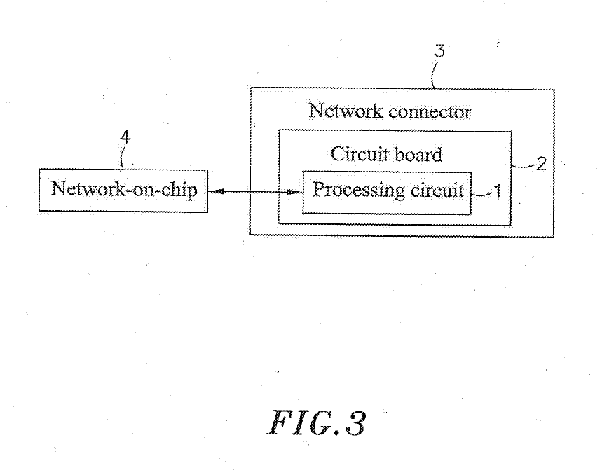

Referring to FIGS. 1 and 3 again, the processing circuit 1 and the network-on-chip 4 can be directly installed in the circuit board 2 and then electrically connected to the network connector 3 (see FIG. 1). Alternatively, the processing circuit 1 can be installed in the circuit board 2 and then installed the circuit board 2 in the network connector 3 that is installed in an external circuit board and electrically connected to a network-on-chip 4 at the external circuit board (see FIG. 3).

In the aforesaid arrangement of the present invention, each first capacitor 131 of each coupling module 13 of the processing circuit 1 of the network signal enhancement circuit assembly at one wire 121 of the respective two-wire channel 12 enables the two wires 121 of the respective two-wire channel 12 to be coupled together. The impedance of the first capacitors 131 is a capacitive reactance of which the unit is ohm (Ω). The capacitive reactance (XC) is measured subject to the equation of XC=1/(2ππf×C), in which: f=frequency and its unit is hertz (Hz); C=capacitance and its unit is farad (F). The invention utilizes the characteristics of the first capacitors 131 to isolate electricity and to couple signal. From the above equation, we can know that the capacitive reactance is indirectly proportional to the operating frequency and the capacitance. Thus, under the condition that the capacitance of the first capacitors 131 remains unchanged, the capacitance reactance will be relatively reduced and the signal attenuation Will also be relatively reduced when the signal frequency is increased, achieving better network linking performance and faster signal transmission speed.

The second capacitors 141 of the aforesaid EMI protection modules 14 exhibit a high pass characteristic. Further, lowering the impedance of the second capacitors 141 can relatively increase the filtered signal frequency. Thus, by means of adjusting the impedance of the second capacitors 141, noises can be removed while the network signal can pass. Subject to the ability of storing electric charges, the second capacitors 141 absorb the lower frequency part of resonant waves in the band, enabling the to frequency part of resonant waves to be shunted to the grounding terminal 142 of the EMI protection modules 14. Thus, the EMI protection modules 14 can effectively remove low frequency noises. Further, the inductors 143 of the EMI protection modules 14 exhibit a low pass characteristic. Subject to the ability of storing energy in the form of a magnetic field when the current is increased and the ability of discharging the energy of the storage magnetic field to compensate current variation when the current is reduced, the inductors 143 absorb the higher frequency part of resonant waves in the band. Thus, when network signals pass through the EMI protection modules 14 toward the network-on-chip 4, high frequency noises and low frequency noises can be effectively removed from the network signals by the EMI protection modules 14, preventing electromagnetic interferences and enhancing signal transmission stability.

In actual application, the invention provides a network signal enhancement circuit assembly comprising a circuit board 2 and a processing circuit 1 installed in the circuit board 2 and electrically coupled between a network connector 3 and a voltage-mode network-on-chip. The processing circuit 1 comprises a plurality of two-wire channels 12 connected in parallel between opposing first connection end 10 and second connection end 11 thereof, and a plurality of coupling modules 13 and EMI protection modules 14 and a signal enhancement module 15 respectively electrically coupled between the first connection end 10 and the second connection end 11 in such a manner that the coupling modules 13 are set between the first connection end 10 and the EMI protection modules 14; the EMI protection modules 14 are set between the coupling modules 13 and the signal enhancement module 15; the signal enhancement, module 15 is set between the EMI protection modules 14 and the second connection end 11. Further, each two-wire channel 12 is formed of two wires 121. Each coupling module 13 comprises two first capacitors 131 respectively electrically connected in series to the two wires 121 of the respective two-wire channel 12. Each EMI protection module 14 comprises two second capacitors 141 that are electrically connected in series and then electrically connected in parallel to the two wires 121 of the respective two-wire channel 12 with the connecting point between the two second capacitors 141 electrically connected to a common grounding terminal 142, and two inductors 143 respectively electrically connected in series to the two second capacitors 141. The signal enhancement module 15 comprises a voltage source 151 that can be city power supply, power generator or storage battery, and a plurality of pull-up resistors 152 electrically connected to the voltage source 151 and respectively electrically connected in parallel to the wires 121 of selected two-wire channels 12. Thus, a predetermined external bias voltage can be obtained through the voltage source 151, and then regulated by the pull-up resistors 152 and then respectively provided by the pull-up resistors 152 to the respective wires 121 of the two-wire channels 12 to enhance signal strength and signal transmission stability,

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A network signal enhancement circuit assembly, comprising a circuit board and a processing circuit installed in said circuit board, said processing circuit comprising a first connection end electrically connected to a network connector for receiving an network signal from said network connector, a second connection end electrically connected to a network-on-chip and adapted for outputting said network signal to said network-on-chip, a plurality of two-wire channels connected in parallel between said first connection end and said second connection end, each said two-wire channel comprising two wires electrically connected in parallel between said first connection end and said second connection end, a plurality of coupling modules respectively electrically coupled between said first connection end and said second connection end, and a plurality of EMI protection modules respectively electrically coupled between said first connection end and said second connection end, wherein said processing circuit further comprises a signal enhancement module electrically coupled between said first connection end and said second connection end and set between said EMI protection modules and said second connection end, said signal enhancement module comprising a voltage source, and a plurality of pull-up resistors electrically connected to said voltage source and respectively electrically connected in parallel to the wires of said two-wire channels.

2. The network signal enhancement circuit assembly as claimed in claim 1, wherein said circuit board carries said network-on-chip thereon; said processing circuit is electrically connected to said network-on-chip at said circuit board and electrically connected to said network connector at an external circuit system.

3. The network signal enhancement circuit assembly as claimed in claim 1, wherein said processing circuit is installed with said circuit board in said network connector and electrically connected to said network-on-chip at an external circuit system.

4. The network signal enhancement circuit assembly as claimed in claim 1, wherein the resistance value of said pull-up resistors of said signal enhancement module is preferably in the range of 100 Ohm˜100K Ohm, or most preferably 10K ohm.

5. The network signal enhancement circuit assembly as claimed in claim 1, wherein each said coupling module comprises two first capacitors respectively electrically connected in series to the two wires of one respective said two-wire channel.

6. The network signal enhancement circuit assembly as claimed in claim 1, wherein each said EMI protection module comprises two second capacitors electrically connected in series and then electrically connected in parallel to the two wires of one respective aid two-wire channel with the connecting point between said two second capacitors electrically connected to a common grounding terminal, and two inductors respectively electrically connected in series to said two second capacitors.
